(19) United States
(12) Patent Application Publication
(10) Pub. No.: US 2022/0261837 A1
(43) Pub. Date: Aug. 18, 2022

(54) Referral tracking application and web-based service

(71) Applicant: Joseph Jablonski, Springfield, VA (US)

(72) Inventor: Joseph Jablonski, Springfield, VA (US)

(21) Appl. No.: 17/725,104

(22) Filed: Apr. 20, 2022

Related U.S. Application Data
(63) Continuation of application No. 17/554,309, filed on Dec. 17, 2021.
(60) Provisional application No. 63/126,776, filed on Dec. 17, 2020.

(51) Int. Cl. G06Q 30/02; G06Q 20/02

(52) U.S. Cl. CPC G06Q 30/0214; G06Q 20/02; G06Q 30/0281

(57) ABSTRACT

An application for a mobile device and/or a web-based service for pairing vendor and customer users, tracking and compiling business to business and individual to business referrals and compensating users for providing referrals.

### CROSS REFERENCE TO RELATED APPLICATIONS

Applicant claims priority to U.S. patent application Ser. No. 17/554,309, filed Dec. 17, 2021, and thence to U.S. provisional patent application 63/126,776, filed Dec. 17, 2020.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is an application for a mobile device and/or a web-based service capable of tracking and compiling referrals from business to business and individual to business, as well as compensating users for providing referrals.

### Background of the Invention

Multiple mobile applications, websites and similar algorithms exist through which customers may input data reviewing or referring different providers of goods and services based on their experience with the provider and the product. Home Advisor, Angie's List and Yelp are examples. These services require a user to fill out automated forms and/or input free-form text rating their experiences with service businesses such as restaurants, electricians, plumbers, hotels, short-term rental properties, etc. These types of services operate as middlemen between users and businesses.

Such services typically compile and aggregate the input data to create a rating system that allows users to quickly see a numerical average communicated as a number or star rating associated with a given service provider. The individual user typically provides his or her feedback as a free service and receives informal consideration in the form of access to other user's data. An unintended consequence of the known system is that users are more likely to take the time to input a review when they have had a particularly memorable experience, good or bad. Further, studies have consistently shown that users are most likely to create a rating as a means of retaliation when they are dissatisfied or angry, resulting in ratings that are significantly lower than the average customer experience.

Despite the proliferation of rating sites, there currently exists no mobile application that actively tracks a business or individual user's referrals for vendors or providers in real time, saves those referrals to a searchable database which can be accessed on an individual basis or grouped with other users' data. Such a database could be accessed by third parties to identify businesses referred by both businesses and individual customers. There also exists no such application that provides a payment scheme to incentivize customers to input ratings and/or references to enhance the amount and quality of the data being input and thus creating a more comprehensive and valuable database.

What is needed is a mobile application and/or a web-based service that allow for tracking, compilation and compensation to members based on their referrals of businesses to third parties.

### BRIEF SUMMARY OF THE INVENTION

In a preferred embodiment, a method of using a mobile application, connected by the internet to a server(s) containing a processor(s) and a database(s) containing a list of users and related information, comprising the steps:
1. prompting a user to establish a user account on the mobile application;
2. establishing the user account by prompting the user to (i) input personal or business information, (ii) choose a designation as one or more of a Referrer, Vendor and/or Customer and (iii) input user's account information through the mobile application to a separate payment application;
3. prompting each Vendor to input information about goods or services to be offered through the application and prompting each Customer to input information about the job(s) the Customer desires to be done;
4. providing each Referrer, and optionally each Customer, with access to lists of one or more Vendors in a geographic area and lists of Customer jobs to be done in a geographic area;
5. providing each Referrer with a means of referring a Vendor to one or more Customers and notifying such Vendor of the referral;
6. providing a means for Vendors to accept a referral within the mobile application;
7. providing the Vendor a means to input a first notice when the project is initialized and a second notice when the project is completed; and
8. prompting a payment from the Customer to the Vendor upon project completion via a third party payment system.

In another preferred embodiment, the method as described herein, wherein step 2 comprises inputting the information within the mobile application, such information is serialized and passed over an encrypted connection to a mobile engagement platform and payment information is never held on such mobile engagement platform.

In another preferred embodiment, the method as described herein, wherein the mobile application is replaced by a web-based platform that can be accessed from a desktop or laptop computer.

In another preferred embodiment, the method as described herein, wherein the Vendor prompt and information input operates over an RPC protocol, generating notifications and emails to alert the Vendor of new referrals.

In another preferred embodiment, the method as described herein, wherein the lists of step 4 are generated on a mobile application backend and displayed by the mobile application.

In another preferred embodiment, the method as described herein, wherein the referral of step 5 is accomplished by the Referrer sending an invitation to initiate a project to one Customer and one Vendor.

In another preferred embodiment, the method as described herein, further comprising, a step 7 of: providing the Customer with a means to offer a project to the Vendor and the Vendor means to accept or reject the project.

In another preferred embodiment, the method as described herein, further comprising a step 8 of: gathering and storing data from each user, such data comprising one or more of Vendors chosen, Vendors referred and Vendor performance.

In an alternate embodiment, a referral and user pairing system, comprising:
a mobile application hosted on a mobile device with a mobile processor, mobile memory, mobile display, input element and transmitter/receiver;
a system server comprising a system processor, system memory, system database and system transmitter/receiver;
a third party payment system; and
a network connecting the mobile application to the system server and the third party payment system; wherein users use the referral and user pairing system to perform the method of claim 1.

In another preferred embodiment, the referral and user pairing system as described herein, wherein an interface module is located on the system memory.

### BRIEF DESCRIPTION OF THE DRAWINGS

FIG. 1 is a schematic drawing evidencing a network environment of the inventive referral and user pairing system.

FIG. 2 is a schematic drawing evidencing an exemplary referral and user pairing system in accordance with the principles of the current invention

FIG. 3 is a flowchart evidencing the user flow for a Referrer using the inventive referral tracking application.

FIG. 4 is a flowchart evidencing the user flow for a Vendor using the inventive referral tracking application.

FIG. 5 is a flowchart evidencing the user flow for a Customer using the inventive referral tracking application.

FIG. 6 is a flowchart evidencing the user interrelated flow for a Customer, a Referrer and a Vendor together using the inventive referral tracking application.

### DETAILED DESCRIPTION OF THE INVENTION

The invention is a system and method for providing an online service, utilizing either a mobile application and/or web-based platform, for generating references and ratings for vendor businesses. User accounts may be either for an individual or a business user, such user being either a referrer, a vendor or a customer. Such accounts can be created by inputting the new client's personal information such as email address, tax identification number, etc., as well as information about goods and services to be offered for vendors.

As used herein, the term “mobile application” means a software application developed specifically for use on small, wireless computing devices, such as smartphones and tablets, rather than desktop or laptop computers. In a preferred embodiment, the mobile application employed in the invention is a mobile engagement platform such as that offered by, for example and without limitation, Kumulos™ or similar known platforms. A “backend” is the part of a mobile application that stores, secures and processes input data. The inventive mobile application will optionally employ a remote procedure call or “RPC” protocol, meaning a software communication protocol that one program (e.g., the mobile application) can use to request a service from a program located in another computer on a network without having to understand the network's details. RPC is used to call other processes on the remote systems like a local system.

Since all individuals and businesses use vendors on a constant basis, the opportunity exists to refer vendor businesses to colleagues and other known third parties. At present, people and businesses do so on an ad-hoc basis, either directly, through social media or message boards or similar communication methods. A registered user of the inventive service will be able to provide references to third parties based on that proprietary information. Further, the service will offer a feature whereby users making referrals are compensated through the service, ideally by linking to the user's own payment app through a service such as Paypal, Zelle or Venmo. The invention will thus provide both individuals and business users with a supplemental income stream for performing referral services that the users would have performed for free anyway.

The mobile application and/or web-based platform will allow users to interface with a hosted database containing information for all other users, wherein each user may register as one or more of a Referrer, a Customer and/or a Vendor. In a preferred embodiment, every Referrer must be a Vendor, but not every Vendor must be a Referrer. As Referrers provide referrals for businesses to third parties, those referrals will be logged by the invention algorithm on the service processor(s) and stored in related databases hosted on servers. As more referrals are made, the amount of searchable reference data gathered will enable users to compare multiple Vendors, make informed choices both about whom to hire and whom to refer. In one embodiment, a menu of services is offered such that the user clicks and then sees subsets in increasing levels of specificity. In another, an indexed project database is searchable by Vendors, allowing the Vendors to directly message Customers directly with quotes.

The system will allow Referrers make referrals by to “inviting” a Customer and a Vendor to pair directly. In one embodiment, this process is begun by Referrer clicking a “Start a Referral” radio button and inputting information regarding the Customer, Vendor and project. Upon receiving the invitation, each of the Customer and Vendor may accept or reject the Referrer's invitation. All input projects will be saved by the system in one of three categories: (i) Invitation, (ii) In Progress, and (iii) Completed. Optionally, an acceptance of a project by a Vendor may be conditioned upon receipt of a deposit or good faith payment of a percentage of the total project cost from the Customer.

Once each of the Customer and Vendor have accepted a project, and any deposit money has been received, the system will prompt the Vendor to submit an indication that the project has begun and is in process. Optionally, for longer-term projects, the system may also allow for the Vendor to submit periodic updates as to the project status, which will be viewable by the Customer. Finally, the Vendor will submit a final update indicating project completion. In alternate embodiments, either the Customer will initiate payment through the third-party payment application upon receive of Vendor's completion notice, or the sending of the completion notice will automatically trigger program instructions to initiate the payment.

It is understood that all users of the application must also have one or more accounts in a third-party payment application, thus allowing Customers to pay Vendors and Vendors to pay Referrers per the inventive application. In another iteration, the inventive application will provide a prompt for a user to input a payment amount directly together with a payment mechanism, for example, a link to a third party payment account or a credit card number. Then, upon completion of the project, the inventive application will automatically prompt payment of the Vendor and Referrer at the agreed-upon levels.

In a preferred embodiment, the inventive service will offer a basic user account for free, with a premium account being offered for a monthly or annual fee. A premium account for vendors will allow their business to be featured, appear higher on a search list, or potentially even be exclusive within a certain geographic area. In one embodiment, the size of the area of exclusivity could be related to the size of the fee payment.

In practice, a user will be able to track a given Vendor's job performance in real time by inputting information or responding to prompts through the application, including:
Customer contact,
Schedule of estimate for work time and cost,
Work schedule,
Work completion,
Money earned by a Referrer, including as a percentage of job cost, and
Compensation paid out monthly

The application may include specific features for types of a service businesses such as restaurants, hotels and rental properties to facilitate ease of use among users who generally focus on one such area.

### Detailed Description of the Figures

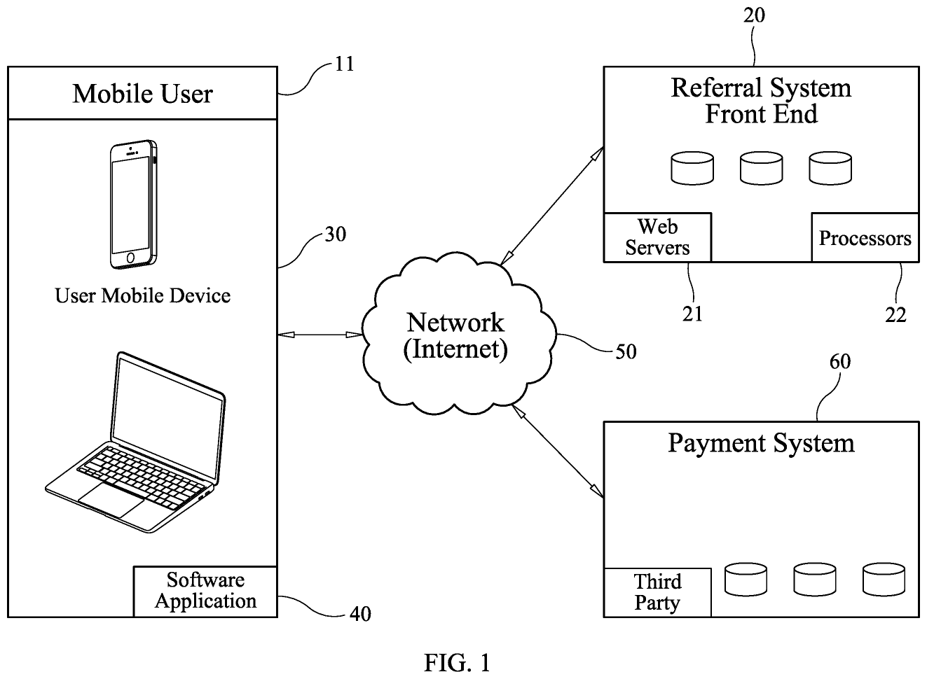

FIG. 1 shows an example network environment the inventive referral and user pairing system 10, including a system front end 20. The system front end may facilitate accessing the system by a user mobile device 30. Each user mobile device 30 may be embodied as a smartphone, tablet, smart watch, personal laptop or desktop computer or similar device capable of performing the functionality of such a device as described herein.

As an example, but not by way of limitation, the user mobile device may access a standard system website 26 via a commercially available web browser. Alternatively, the user mobile device 30 may download and access software comprising a mobile application 40. In either event, the mobile device may use a communication network 50, such as the Internet, to communicate with the servers and processors comprising the referral and user pairing system 10. Data input by users is thus transmitted to and processed by the system front end and system processed data is then transmitted back to the user mobile device, in each event via the network 50.

When registering for an account on the referral and user pairing system, the user is also prompted to register with a third-party online payment system 60. A user's registration with such payment system establishes a communication link via the network 50 between the payment system and the referral and user pairing system, allowing the referral and user pairing system to prompt the payment system to initiate payment for completed projects in accordance with user payment prompts. Such prompts will trigger communication via the network directly between the payment system and the user mobile device 30 evidencing payments made or received.

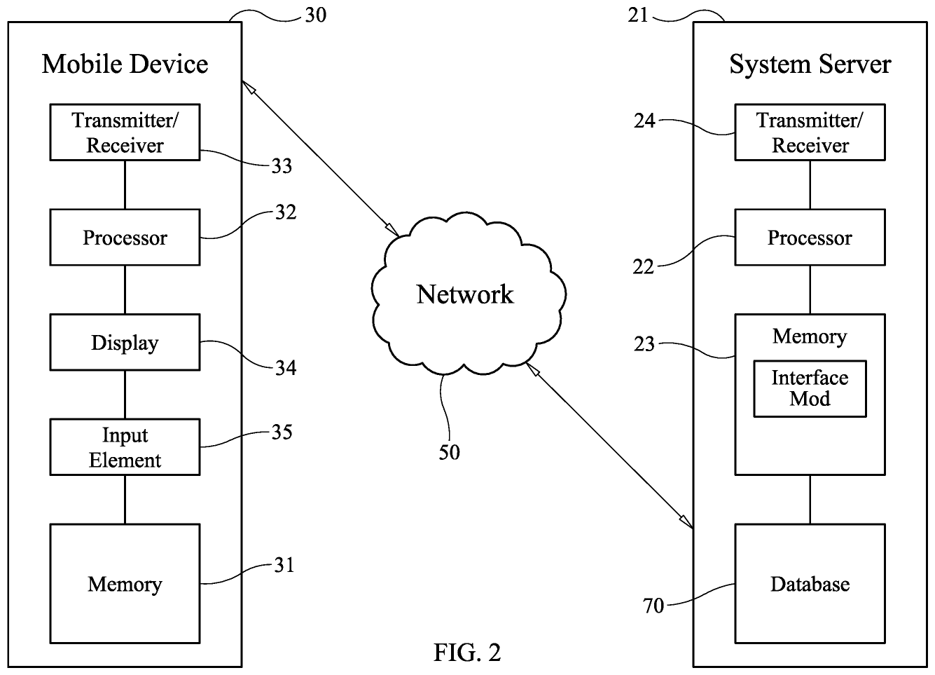

FIG. 2 is a further schematic drawing evidencing an exemplary referral and user pairing system 10 in accordance with the principles of the current invention. The system includes one or more user mobile devices 30, one or more system servers 21, one or more system databases 25 and one or more communication networks 50.

Each mobile device may include at least one mobile processor 32, mobile memory 31 and mobile transmitter/receiver 33. The mobile transmitter/receiver may be a wireless or wired connection to a modem. The mobile processor may be one or more central processing units (CPU) for performing functions described herein. Each mobile device will also comprise a mobile display 34 allowing the user 11 to view and interact with the system, as well as a mobile input element 35, such as a touchscreen, keyboard, mouse or microphone for inputting user commands. Mobile memory 31 may comprise any volatile or non-volatile memory, including but not limited to a hard drive, flash drive or similar device. The memory may store the downloadable mobile application 40, including program instructions, records of transactions, input data, etc. Alternatively, any such data may be stored on a system memory 23 and accessed remotely, and also be saved to a database 70 either located on system server 21, as pictured, or remotely.

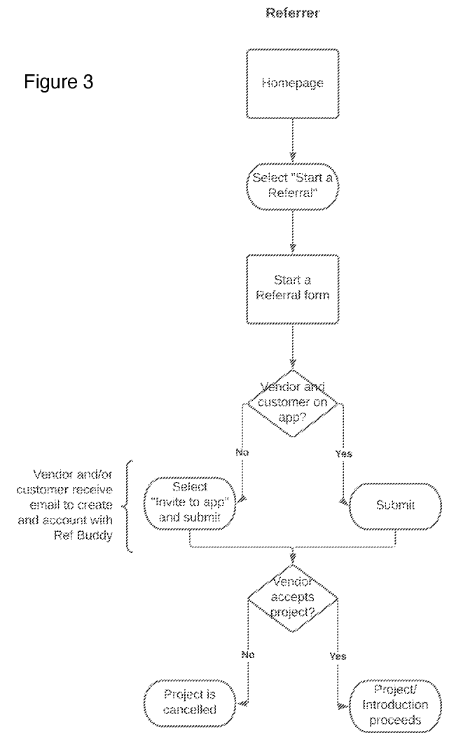

Each system server 21 will comprise at least one system processor 22, system memory 23 and system server transmitter/receiver 24. The system transmitter/receiver may be a wireless or wired connection to a modem. The system processor may be one or more central processing units (CPU) for performing functions described herein. System memory 23 may store program instructions such as those for interface module 27, among other modules. Interface module 26 includes program instructions, which when executed by system processor 22, causes the processor to perform one of the interface user flow processes detailed in FIGS. 3-5.

Referral and user pairing system 10 may also include one or more databases (collectively referred to as “database 70”). Database 70 may be a structured query language (SQL) based database or other type known in the art. Database may store user input data and other data required for the operation of system servers 21. In the illustrated embodiment, the database is located on the server, but remote databases are also possible in alternate embodiments. Network 50 may include the Internet, an internet protocol network, wireless communication network, cellular communications network and publicly switched telephone network, among other types of networks known in the art that may be established as a wide area network (WAN) and/or local area network (LAN).

FIG. 3 shows a flow chart evidencing the user flow for a Referrer on the inventive mobile application or web-based referral system, including the steps:
1. Referrer accesses a homepage on the mobile application;
2. Select “Start a Referral”;
3. Complete a referral form;
4. Select “invite to app”, only if both Vendor and Customer are not already logged in;
5. Select “Submit”;
6. Vendor accepts or rejects project;

6A. If Vendor accepts, proceed with project introduction; or

6B. If Vendor rejects, cancel the project.

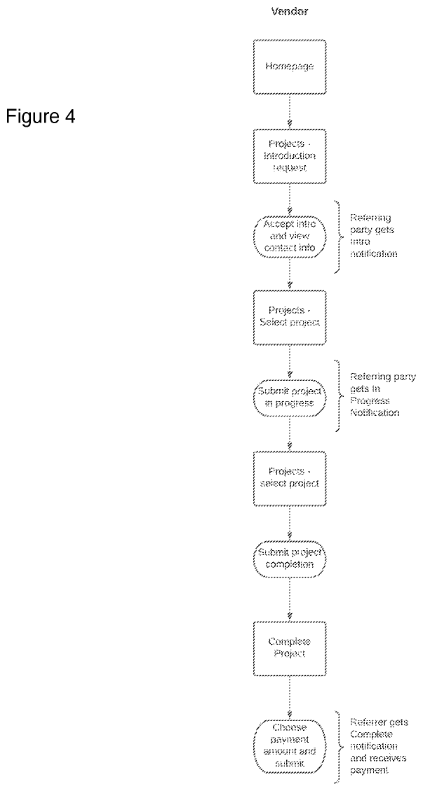

FIG. 4 shows a flow chart evidencing the user flow for a Vendor on the inventive mobile application or web-based referral system, including the steps:
1. Vendor accesses the homepage on a mobile application;
2. Receives introduction request from either Referrer or Customer;
3. Accepts introduction and reviews
4. Reviews project information and selects proceed with project;
5. Selects project in progress, indicating to Customer that the project is underway;
6. Selects project completed;
7. Sends invoice/payment request; and
8. Receives Customer payment, less any referral fee due to Referrer.

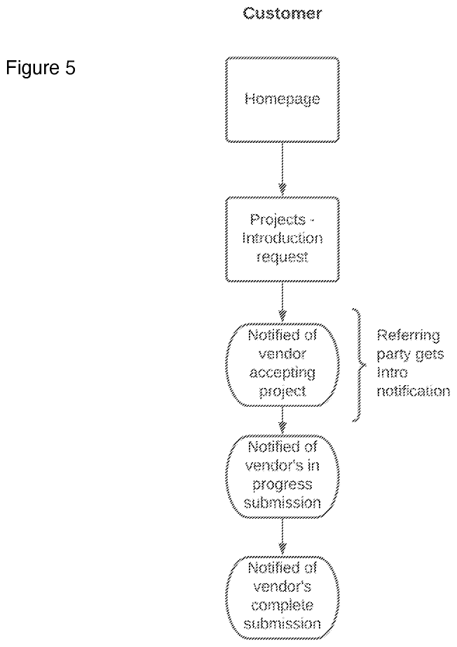

FIG. 5 shows a flow chart evidencing the user flow for a Customer on the inventive mobile application or web-based referral system, including the steps:
1. Customer accesses the Homepage;
2. Submits an introduction request to a Vendor;
3. Receives notice of Vendor acceptance or rejection of project, if accepted;
4. Receives notice of Vendor's in progress submission of project;
5. Receives notice of Vendor's complete submission of project.

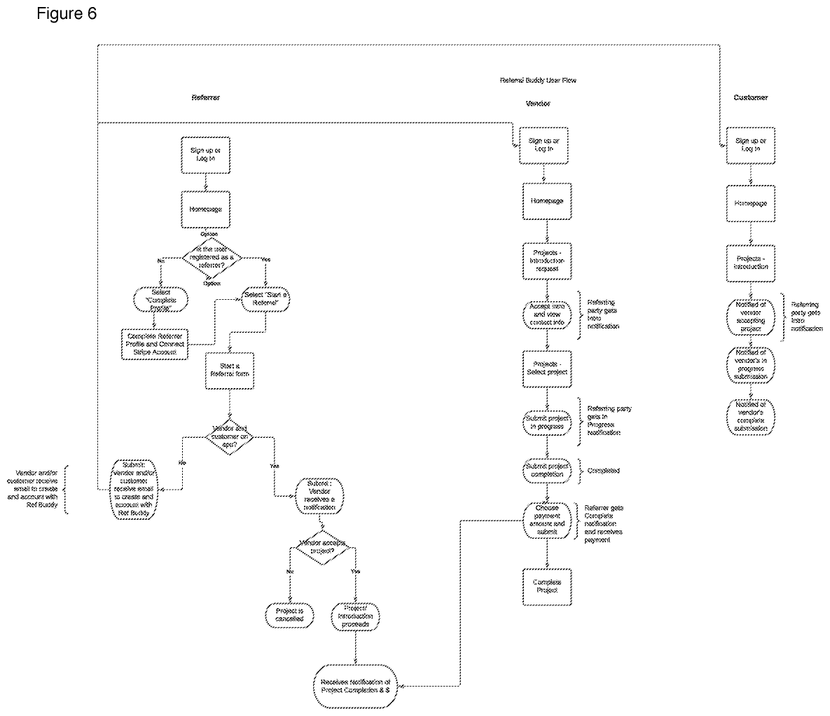

FIG. 6 shows a comprehensive flow chart combining the Referrer, Vendor and Customer user flows from each of FIGS. 3-5 and thus evidencing the interrelation of the use actions by each project participant in initiating and completing a project.

It must be noted that the steps and features cited individually in the claims can be combined with each other in any technologically meaningful manner (also across the boundaries of categories, e.g. between system and method) and represent other embodiments of the invention. The description, in particular in connection with the figures, additionally characterizes and specifies the invention.

### REFERENCE COMPONENTS

10 Referral and user pairing system
11 User
20 System front end
21 System server(s)
22 System processor
23 System memory
24 System transmitter/receiver
25 System database
26 System website
27 Interface module
30 User mobile device
31 Mobile memory
32 Mobile processor
33 Mobile transmitter/receiver
34 Mobile display
35 Mobile input element
40 Downloadable mobile application
50 Network
60 Third party payment system
70 Database

The disclosures herein, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

I claim:

1. A method of using a mobile application, connected by the internet to a server(s) containing a processor(s) and a database(s) containing a list of users and related information, comprising the steps:
1. prompting a user to establish a user account on the mobile application;
2. establishing the user account by prompting the user to (i) input personal or business information, (ii) choose a designation as one or more of a Referrer, Vendor and/or Customer and (iii) input user's account information through the mobile application to a separate payment application;
3. prompting each Vendor to input information about goods or services to be offered through the application and prompting each Customer to input information about the job(s) the Customer desires to be done;
4. providing each Referrer, and optionally each Customer, with access to lists of one or more Vendors in a geographic area and lists of Customer jobs to be done in a geographic area;
5. providing each Referrer with a means of referring a Vendor to one or more Customers and notifying such Vendor of the referral;
6. providing a means for Vendors to accept a referral within the mobile application;
7. providing the Vendor a means to input a first notice when the project is initialized and a second notice when the project is completed; and
8. prompting a payment from the Customer to the Vendor upon project completion via a third party payment system.

2. The method of claim 1, wherein step 2 comprises inputting the information within the mobile application, such information is serialized and passed over an encrypted connection to a mobile engagement platform and payment information is never held on such mobile engagement platform.

3. The method of claim 1, wherein the mobile application is replaced by a web-based platform that can be accessed from a desktop or laptop computer.

4. The method of claim 1, wherein the Vendor prompt and information input operates over an RPC protocol, generating notifications and emails to alert the Vendor of new referrals.

5. The method of claim 1, wherein the lists of step 4 are generated on a mobile application backend and displayed by the mobile application.

6. The method of claim 1, wherein the referral of step 5 is accomplished by the Referrer sending an invitation to initiate a project to one Customer and one Vendor.

7. The method of claim 1, further comprising, after step 6:
7. providing the Customer with a means to offer a project to the Vendor and the Vendor means to accept or reject the project.

8. The method of claim 1, further comprising, after claim 7,
8. gathering and storing data from each user, such data comprising one or more of Vendors chosen, Vendors referred and Vendor performance.

9. A referral and user pairing system, comprising:
a mobile application hosted on a mobile device with a mobile processor, mobile memory, mobile display, input element and transmitter/receiver;
a system server comprising a system processor, system memory, system database and system transmitter/receiver;
a third party payment system; and
a network connecting the mobile application to the system server and the third party payment system;
wherein users use the referral and user pairing system to perform the method of claim 1.

10. The referral and user pairing system of claim 9, wherein an interface module is located on the system memory.
